(19) United States
(12) Patent Application Publication
(10) Pub. No.: US 2012/0164868 A1
(43) Pub. Date: Jun. 28, 2012

(54) RJ-45 CONNECTOR ASSEMBLY AND ASSISTING APPARATUS FOR UNPLUGGING RJ-45 CONNECTOR

(75) Inventors: CHUNG-CHI HUANG, Tu-Cheng (TW); GUANG-DONG YUAN, Shenzhen City (CN); HAI-QING ZHOU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/045,521

(22) Filed: Mar. 10, 2011

(30) Foreign Application Priority Data
Dec. 28, 2010 (CN) 201010609111.4

(51) Int. Cl. H01R 13/627

(52) U.S. Cl. 439/353

(57) ABSTRACT

A Registered Jack-45 (RJ-45) connector assembly includes an RJ-45 connector, and an assisting apparatus for unplugging the RJ-45 connector. The RJ-45 connector includes a slanted resilient latch. The assisting apparatus includes a latching portion and a pressable portion. A receiving slot is defined in the front end of the latching portion, to engage with the resilient latch of the RJ-45 connector. When the pressable portion is pressed, the assisting apparatus drives the resilient latch of the RJ-45 connector to deform and disengage from a connector of an electronic device.

### BACKGROUND

1. Technical Field

The present disclosure relates to a Registered Jack-45 (RJ-45) connector assembly, and an assisting apparatus for unplugging an RJ-45 connector.

2. Description of Related Art

Registered Jack-45 (RJ-45) connectors are widely used in network communication. However, unplugging an RJ-45 connector manually from a connector of an electronic device can be difficult and inconvenient because of limited or cramped operation space.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawing, all the views are schematic, and like reference numerals designate corresponding parts throughout the several views.

FIG. 1 is an exploded, isometric view of an embodiment of a Registered Jack-45 (RJ-45) connector assembly together with a connector, the RJ-45 connector assembly including an assisting apparatus.

FIG. 2 is an enlarged, inverted view of the assisting apparatus of FIG. 1.

FIG. 3 is an assembled, isometric view of FIG. 1.

FIG. 4 is a cross-sectional view taken along the line IV-IV of FIG. 3.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

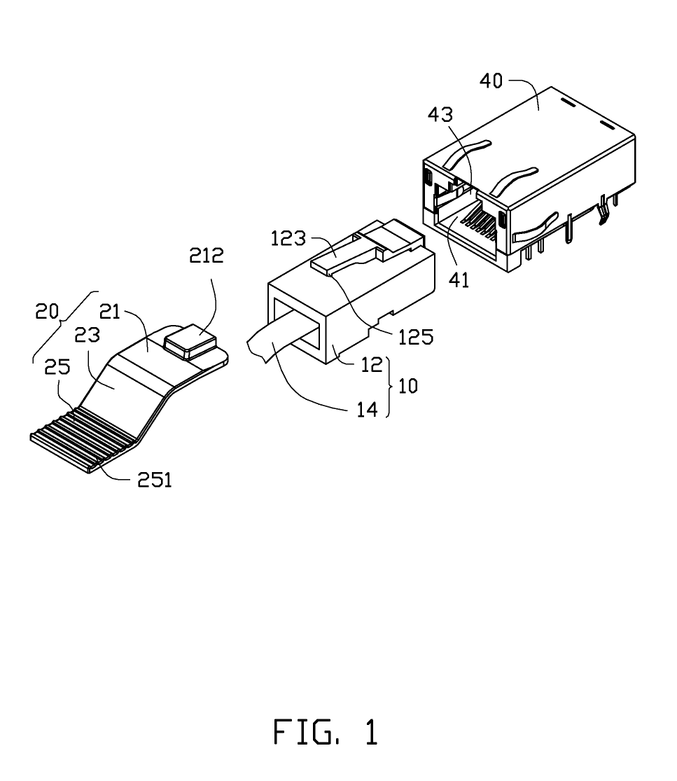

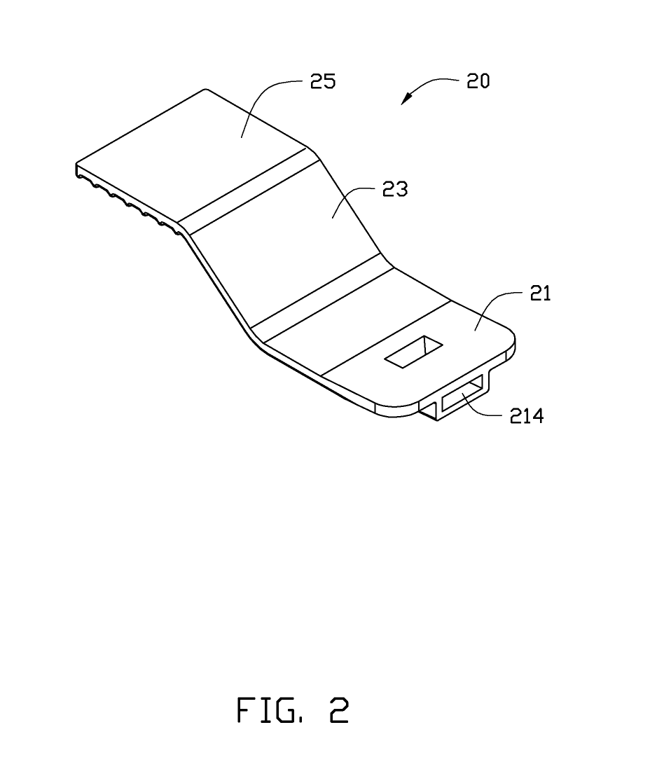

Referring to FIGS. 1 and 2, an embodiment of a Registered Jack-45 (RJ-45) connector assembly includes an RJ-45 connector 10, and an assisting apparatus 20.

The RJ-45 connector 10 includes a main body 12, and a cable 14 connected to the rear end of the main body 12. A resilient latch 123 extends up and back from the front end of the top of the main body 12. A hooking portion 125 extends down from the rear end of the resilient latch 123.

The assisting apparatus 20 includes a latching portion 21, a connection portion 23 slantingly extending down from the rear end of the latching portion 21, and a pressable portion 25 extending from the rear end of the connection portion 23. The pressable portion 25 is substantially parallel to the latching portion 21. A receiving portion 212 protrudes from the front end of the top of the latching portion 21. A substantially L-shaped receiving slot 214 having an inside corner is defined in the receiving portion 212, with a first end of the receiving slot 214 extending through the front end of the receiving portion 212, and a second end of the receiving slot 214 extending through a bottom of the latching portion 21. A plurality of skid-resistant protrusions 251 is formed on the top of the pressable portion 25.

The RJ-45 connector 10 can be electrically connected to a connector 40 of an electronic device. An opening 41 is defined in the rear end of the connector 40, and a latching slot 43 is defined in the rear end of the connector 40 communicating with the top of the opening 41.

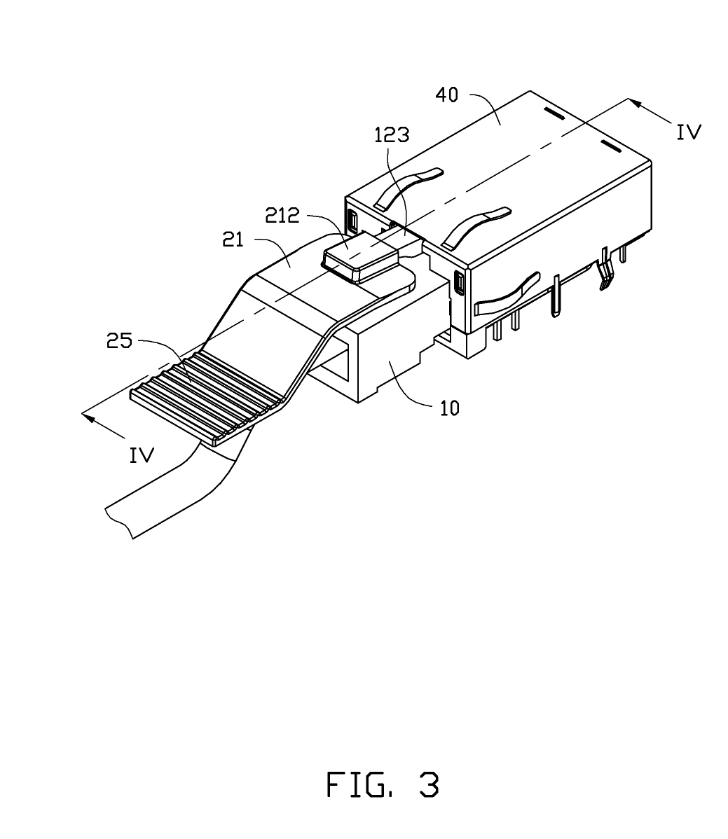

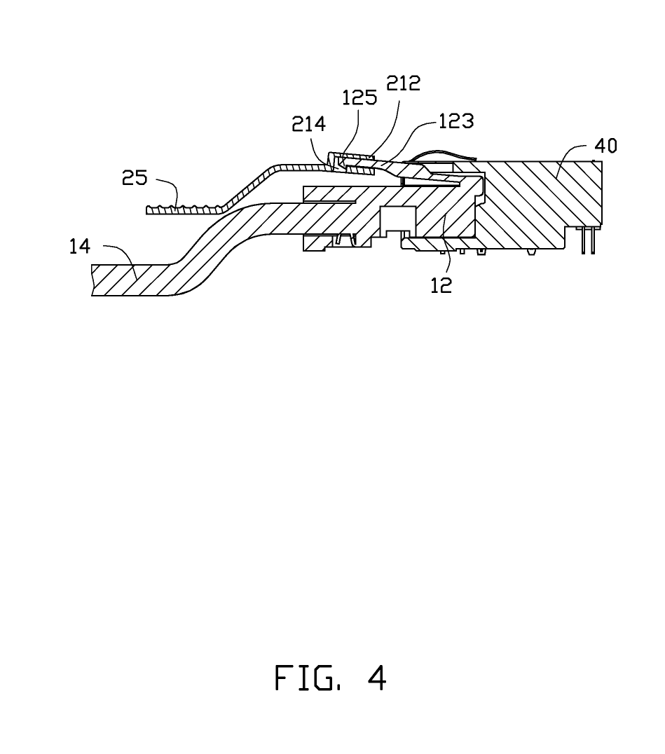

Referring to FIGS. 3 and 4, to electrically connect the RJ-45 connector 10 to the connector 40, the front end of the RJ-45 connector 10 is inserted into the opening 41 of the connector 40. The front end of the resilient latch 123 of the RJ-45 connector 10 engages with the latching slot 43 of the connector 40. Thereby, the RJ-45 connector 10 is electrically connected to the connector 40.

To unplug the RJ-45 connector 10 from the connector 40, the rear end of the resilient latch 123 of the RJ-45 connector 10 is inserted into the receiving slot 214 of the receiving portion 212 of the assisting apparatus 20 from the first end of the receiving slot 214. The hooking portion 125 of the resilient latch 123 engages with the inside corner of the receiving slot 214. Thereby, the RJ-45 connector 10 is connected to the assisting apparatus 20. The pressable portion 25 of the assisting apparatus 20 is pressed down, to drive the resilient latch 123 to deform downwards and disengage from the latching slot 43 of the connector 40. Therefore, the RJ-45 connector 10 can be directly unplugged from the connector 40.

In this embodiment, the operation distance of the resilient latch 123 of the RJ-45 connector 10 is increased by using the assisting apparatus 20, therefore, unplugging the RJ-45 connector 10 becomes easy.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. An assisting apparatus for unplugging a Registered Jack-45 (RJ-45) connector having a resilient latch, the assisting apparatus comprising:
a latching portion defining a receiving slot in the front end of the latching portion, for receiving the resilient latch of the RJ-45 connector;
a connection portion slantingly extending from the rear end of the latching portion; and
a pressable portion extending from the rear end of the connection portion.

2. The assisting apparatus of claim 1, wherein the pressable portion is substantially parallel to the latching portion.

3. The assisting apparatus of claim 1, wherein a plurality of skid-resistant protrusions is formed on the top of the pressable portion.

4. The assisting apparatus of claim 1, wherein a receiving portion protrudes from the front end of the top of the latching portion, the receiving slot is defined in the receiving portion and extends through the front end of the receiving portion.

5. A Registered Jack-45 (RJ-45) connector assembly, comprising:
an RJ-45 connector comprising a main body, and a resilient latch extending up and back from the front end of the top of the main body; and
an assisting apparatus for unplugging the RJ-45 connector, the assisting apparatus comprising a latching portion and a pressable portion, wherein a receiving slot is defined in the front end of the latching portion, to engage with the resilient latch of the RJ-45 connector, when the pressable portion is pressed, the assisting apparatus drives the resilient latch of the RJ-45 connector to deform.

6. The RJ-45 connector assembly of claim 5, wherein a hooking portion protrudes from the rear end of the resilient latch, the receiving slot of the assisting apparatus is substantially L-shaped and comprises an inside corner, when the resilient latch of the RJ-45 connector is inserted into the receiving slot of the assisting apparatus, the hooking portion of the resilient latch engages with the corner of the receiving slot.

7. The RJ-45 connector assembly of claim 6, further comprising a connection portion slantingly extending from the rear end of the latching portion, wherein the pressable portion extends from the rear end of the connection portion.

8. The RJ-45 connector assembly of claim 7, wherein the pressable portion is substantially parallel to the latching portion.

9. The RJ-45 connector assembly of claim 6, wherein a receiving portion protrudes from the front end of the top of the latching portion, the receiving slot is defined in the receiving portion and extends through the front end of the receiving portion and the bottom of the latching portion.

10. The RJ-45 connector assembly of claim 6, wherein a plurality of skid-resistant protrusions is formed on the top of the pressable portion.
